(19) United States
(12) Patent Application Publication
(10) Pub. No.: US 2026/0365167 A1
(43) Pub. Date: Nov. 19, 2026

(54) SYSTEMS AND METHODS FOR MULTIPLE TRAILER FUNCTION CONTROL USING ROTARY INPUT

(71) Applicant: Ford Global Technologies, LLC, Dearborn, MI (US)

(72) Inventors: Laudy P. Mora, Mexico City (MX); Ricardo A. Miranda, Mexico City (MX); Eduardo Hernandez, Mexico City (MX); Enrique Denicia, Mexico City (MX)

(73) Assignee: Ford Global Technologies, LLC, Dearborn, MI (US)

(21) Appl. No.: 19/210,509

(22) Filed: May 16, 2025

(51) Int. Cl. B60W 30/18; B60W 10/18; B60W 10/20; B60W 50/14; G06F 3/0362

(52) U.S. Cl. CPC B60W 30/18036; B60W 10/18; B60W 10/20; B60W 50/14; B60W 2050/146; B60W 2300/14; B60W 2510/1005; B60W 2520/10; B60W 2540/215; B60W 2710/18; B60W 2710/20; B60W 2720/24; G06F 3/0362

(57) ABSTRACT

A control system for a vehicle having a trailer brake controller, and a steering system includes a vehicle human machine interface having a rotatable rotary element and a button positioned adjacent the rotatable rotary element. The control system further includes a controller operating in a driving mode including receiving a first rotary input from the rotatable rotary element and outputting a trailer brake actuation signal to the trailer brake control module proportional to a magnitude of the rotary input. Responsive to receipt of an activation signal received from the button, the controller further operates in a trailer backup mode, including receiving a second rotary input from the rotatable rotary element and outputting a vehicle steering command to the steering system based on a magnitude and direction of the second rotary input.

### FIELD OF THE DISCLOSURE

The present disclosure generally relates to a vehicle control system, and more particularly to a control system that operates multiple trailering functions using a single rotary input device.

### BACKGROUND OF THE DISCLOSURE

Various aspects of trailer control can be implemented in connection with a towing vehicle. These functions are often achieved using separate interfaces dedicated to the specific functions. For example, a trailer backup assist knob can be used for vehicle assisted maneuvering of a trailer during reversing operation of the towing vehicle. Additionally, a vehicle may include a trailer brake switch for activating and adjusting trailer brakes that may be included in a trailer connected with the towing vehicle. A LIN-bus type switch with a spring-loaded slider and integrated buttons for gain adjustment are included in the vehicle for controlling such functions. In particular, the switch activates the trailer brakes by connection with a trailer tow module that also orchestrates trailer lighting (stop, turn signals), and battery charging, for example, in addition to the trailer braking control.

### SUMMARY OF THE DISCLOSURE

According to one aspect of the present disclosure, a control system for a vehicle having a trailer brake controller, and a steering system includes a vehicle human machine interface having a rotatable rotary element and a button positioned adjacent the rotatable rotary element. The control system further includes a controller operating in a driving mode including receiving a first rotary input from the rotatable rotary element and outputting a trailer brake actuation signal to the trailer brake control module proportional to a magnitude of the rotary input. Responsive to receipt of an activation signal received from the button, the controller further operates in a trailer backup mode, including receiving a second rotary input from the rotatable rotary element and outputting a vehicle steering command to the steering system based on a magnitude and direction of the second rotary input.

Embodiments of the first aspect of the invention can include any one or a combination of the following features:
The vehicle human machine interface can further include a display screen, and, further responsive to receiving the first rotary input from the rotatable rotary element when operating in the driving mode, the controller can present a trailer brake gain interface on the display screen, the trailer brake gain interface including a graphical representation of a brake gain setting used to derive the trailer brake actuation signal.
The trailer brake gain interface can further include at least one virtual input corresponding with an input to adjust the brake gain setting.
The controller can operate in the trailer backup mode, responsive to receipt of the trailer backup activation signal, only upon detection of at least one prerequisite vehicle condition.
The prerequisite vehicle condition can be a vehicle transmission being configured in a reverse gear.
The prerequisite vehicle condition can further include a vehicle speed being below a threshold speed.
The controller can operate in the trailer backup mode, only upon detection of the at least one prerequisite vehicle condition within a predetermined time interval of receiving the trailer backup activation signal.
The controller can output the trailer brake actuation signal to the trailer brake control module only upon the first rotary input corresponding with rotation of the rotatable rotary element in the clockwise direction.
The human machine interface can further include at least one illuminable element indicating controller operation in a respective one of the driving mode or the trailer backup mode.
The button can be positioned within an interior of the rotatable rotary element.

According to another aspect of the present disclosure, a control system for a vehicle having a trailer brake controller, and a steering system includes a vehicle human machine interface including a rotatable rotary element, a button positioned adjacent the rotatable rotary element, and display screen. The control system further includes a controller receiving a first rotary input from the rotatable rotary element, outputting a trailer brake actuation signal to the trailer brake control module proportional to a magnitude of the rotary input, and presenting a trailer brake gain interface on the display screen. The trailer brake gain interface includes a graphical representation of a brake gain setting used to derive the trailer brake actuation signal.

According to another aspect of the present disclosure, a vehicle includes a steering system, a trailer brake controller, and a vehicle human machine interface including a rotatable rotary element, a button positioned adjacent the rotatable rotary element, and a display screen. The vehicle further includes a controller that operates in a driving mode including receiving a first rotary input from the rotatable rotary element, outputting a trailer brake actuation signal to the trailer brake control module proportional to a magnitude of the rotary input, and presenting a trailer brake gain interface on the display screen. The trailer brake gain interface includes a graphical representation of a brake gain setting used to derive the trailer brake actuation signal. Responsive to receipt of an activation signal received from the button, the controller operates in a trailer backup mode that includes receiving a second rotary input from the rotatable rotary element and outputting a vehicle steering command to the steering system based on a magnitude and direction of the second rotary input.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of a vehicle connected with a trailer and including a control system according to the present disclosure;

FIG. 2 is a diagram of the control system and related vehicle components;

FIG. 3 is a perspective view of related art control devices associated with aspects of trailer towing functions;

FIG. 4 is a front view of a rotary input device used by the present system for control of multiple trailer towing functions carried out by the system of the disclosure;

FIG. 5 is a front view of a human machine interface used for further control of related trailer towing functions;

FIG. 6 is a perspective view of a vehicle interior showing use of the rotary input device as an input according to control of a trailer towing function; and

FIG. 7 is a flow chart showing a method for controlling the system of the present disclosure according to a further aspect thereof.

### DETAILED DESCRIPTION OF THE PREFERRED EMBODIMENTS

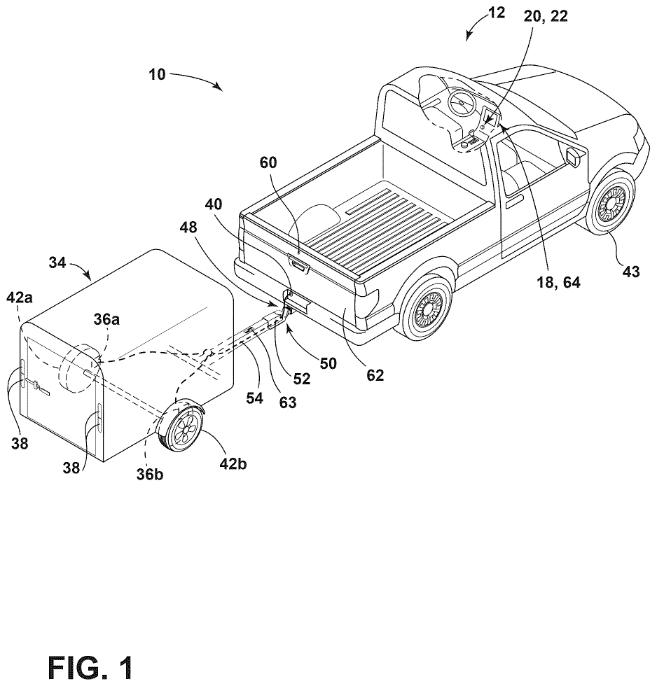

For purposes of description herein, the terms “upper,” “lower,” “right,” “left,” “rear,” “front,” “vertical,” “horizontal,” “interior,” “exterior,” and derivatives thereof shall relate to the device as oriented in FIG. 1. However, it is to be understood that the device may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

Ordinal modifiers (i.e., “first”, “second”, etc.) may be used to distinguish between various structures of the disclosed system in various contexts, but that such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a.” does not, without more constraints, preclude the existence of additional identical elements in the process, method, article, or apparatus that comprises the element.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about”, “approximately”, or “substantially” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

Referring to FIG. 1, reference numeral 10 generally designates a control system for a vehicle 12 having a trailer brake control module 14, and a steering system 16. The control system 10 includes a vehicle human machine interface (“HMI”) 18 having a rotatable rotary element 20 and a button 22 positioned adjacent the rotatable rotary element 20. The control system 10 further includes a controller 24 operating in a driving mode including receiving a first rotary input 26a from the rotatable rotary element 20 and outputting a trailer brake actuation signal 28 to the trailer brake control module 14 proportional to a magnitude of the first rotary input 26a. Responsive to receipt of an activation signal 28 received from the button 22, the controller 24 further operates in a trailer backup mode, including receiving a second rotary 26b input from the rotatable rotary element 20 and outputting a vehicle steering command 32 to the steering system 16 based on a magnitude and direction of the second rotary input 26b.

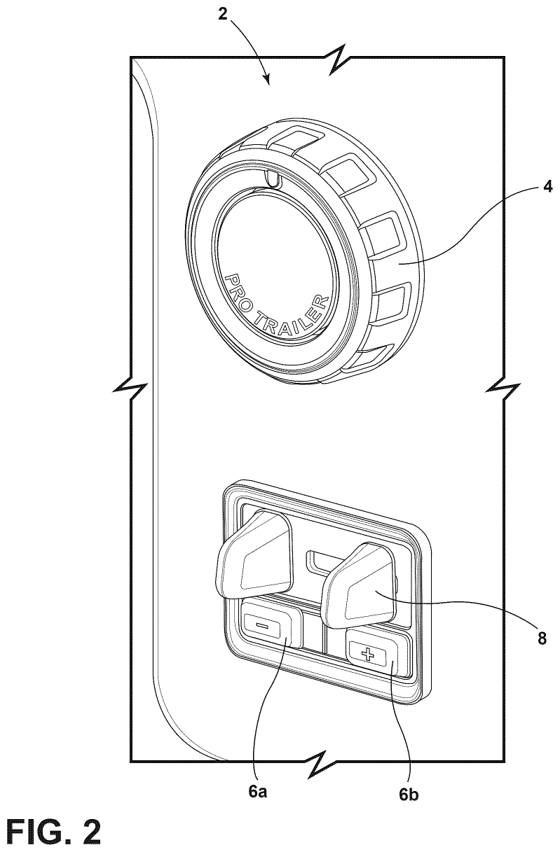

As shown in FIGS. 1 and 2, system 10 is included in vehicle 12, which is depicted as a pickup truck but can be any vehicle capable of towing trailer 34. In one example, the vehicle 12 can be a vehicle with a towing capacity great enough to tow a trailer 34 of a size and/or weight that may require its own trailer brakes 36a, 36b. Such trailer brakes 36a, 36b are generally known and, as depicted, may be operated by trailer brake control module 14 positioned within the vehicle. In one implementation, the trailer brake control module 14 can be an integrated trailer brake module (“ITRM”), which may, as shown in the example of FIG. 2, be incorporated into the vehicle controller 24 as a component thereof. In any example, the trailer brake control module can be configured to manage trailer lighting 38 (stop, turn, park, reverse, and fog lamps) and braking. The trailer brake control module 14 can also provide additional features including trailer lamp 38 diagnostics and trailer lamp 38 detection. Trailer brake control module 14 may also be configured to detects various trailer electrical conditions, including short-to-ground, short-to-battery, and lamp 38 outages. It may also be able to verify trailer 34 connection by measuring the electrical characteristics of the trailer lamps 38.

The trailer brake control module 14 connects with the trailer brakes 36a, 36b and trailer lamps 38 by way of an electrical coupling 40. When connected, the trailer brake signal 28 is transmitted from the trailer brake control module 14 to the individual trailer brakes 36a and 36b, which are respectively operably coupled with trailer wheels 42a and 42b to selectively forcibly slow the rotation of wheels 42a and 42b in a coordinated manner with braking of vehicle 12 by way of the vehicle brake control 46, which acts responsive to, for example, a brake pedal 45 being depressed and actuates the vehicle brake system 46. In this manner, the trailer brakes 36a and 36b can be in the form of disc brakes, drum brakes, or the like and can be generally similar to other known vehicle brakes. In one example, trailer brakes 36a and 36b can be electromechanically actuated such that trailer brakes 36a and 36b operate by directly receiving an electrical signal that drives an electromechanical actuator within the braking mechanism according to the voltage, for example, of the signal 28. In an alternative arrangement, the trailer brakes 36a and 36b can be included in what is known as an electric-over-hydraulic system in which trailer brakes 36a and 36b are hydraulically actuated brake units that operate by increased pressure of a hydraulic fluid supply coupled with trailer brakes 36a and 36b. In such an implementation, the system 10 can further include a trailer brake actuation module that is mounted on the trailer 34 and includes a hydraulic pump that pressurizes brake fluid within lines connecting trailer brake actuation module with the trailer brakes 36a and 36b according to the trailer brake control signal 28 that trailer brake actuation module receives from the trailer brake control module 14.

In any of the specific implementations of the trailer brakes 36a, 36b, described herein and otherwise known, it can be appreciated that the braking torque applied to trailer wheels 42a and 42b is directly proportional to a characteristic, such as the voltage, of the trailer brake control signal 28. In this manner, and as discussed above, the trailer brake control module 14 can receive a torque demand signal 44 from a vehicle brake control module 46 and output the trailer brake control signal 28 to the trailer brakes 36a, 36b to generate the braking torque on trailer wheels 42a and 42b that is commensurate with and proportionate to the desired braking of vehicle 12. This allows trailer 34 itself, by way of trailer brakes 36a, 36b to compensate for the additional weight and resulting momentum of the trailer 34 and the effect thereof on the ability of the combined vehicle 12 and trailer 34 during braking. As illustrated, trailer 34 may be coupled with vehicle 12 by way of a hitch receiver 48 that is coupled with the frame of vehicle 12, hitch receiver 48 having a hitch ball 50 coupled therewith that, in turn, couples in an articulating manner with a trailer hitch 52 disposed on a tongue 54 of trailer 34. Other trailer arrangements and towing assemblies are also known and useable in connection with system 10, including a gooseneck trailer that couples with a “fifth wheel” positioned above and longitudinally and laterally aligned with a center of the rear axle of vehicle 12. Regardless of the particular coupling mechanism, this articulating coupling of vehicle 12 with trailer 34 understandably adds the weight of the trailer 34 and any payload carried by trailer 34 to the total weight that vehicle 12 must accelerate to move and decelerate (i.e., negatively accelerate), in the absence of trailer brakes 36a, 36b, to slow or stop.

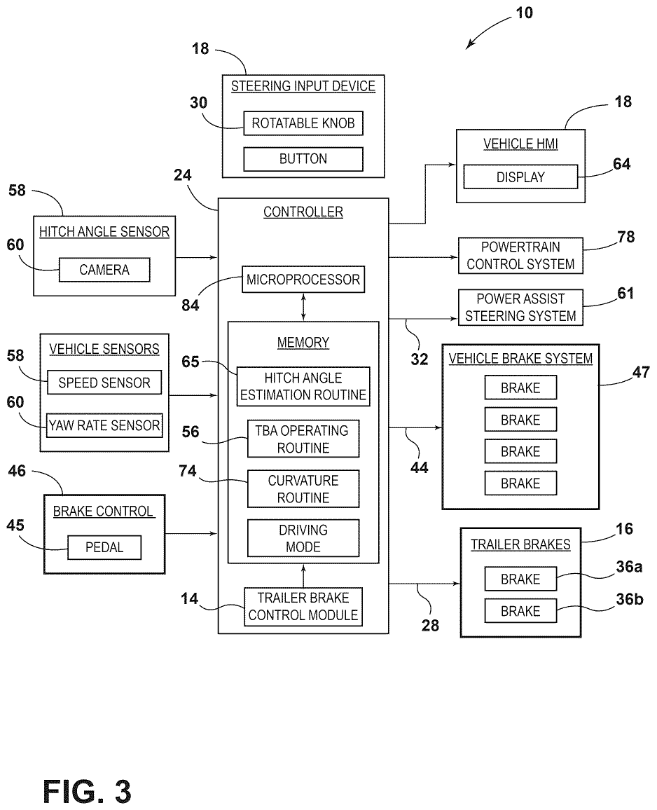

As further shown in FIG. 3, the present system 10 also includes trailer backup assist functionality, an example of which is described in detail in commonly-assigned U.S. Pat. No. 10,479,334 the entire disclosure of which is incorporated by reference herein. With respect to the general operation of the trailer backup assist aspect of system 10, the controller 24 runs a backup assist operating routine 56 that uses a curvature input received by the controller 24. Upon receiving the desired curvature, the controller 24 generates the steering command 32, which is output to the vehicle steering system 16, for the vehicle 12 to guide the trailer 34 on the desired curvature based on an estimated hitch angle, between the longitudinal axes of the vehicle 12 and the trailer 34, and a kinematic relationship between the trailer 34 and the vehicle 12 (using curvature routine 74). The illustrated system 10 includes a hitch angle sensor 58 that employs a camera 60 (e.g., video imaging camera) that may be located proximate an upper region of the vehicle tailgate 62 at the rear of the vehicle 12, as shown, such that the camera 60 may be elevated relative to the tongue 54 of the trailer 14, in the illustrated example of FIG. 1, the system 10 utilizes a target 63 placed on the trailer 14 to allow the system 10 to utilize information acquired via image acquisition and processing of the target 63 to determine the hitch angle (using hitch angle routine 65), although it is contemplated that the camera 60 may capture images of the trailer 14 without a target 63 to determine the hitch angle. The system 10 is in communication with the vehicle system 16 to operate the steered wheels 43 (FIG. 1) of the vehicle 12 for moving the vehicle 12 in such a manner that the trailer 34 generally follows the desired curvature, per the curvature input.

As shown in FIG. 2, related implementations of a vehicle control system that includes the trailer backup assist functionality discussed above have included a steering input device 2 that is connected to the system's controller for allowing communication of information therebetween. The steering input device 2 provides the system with information for defining the desired backing path of travel of the trailer 14 for the controller 24 to process and generate steering commands. More specifically, the steering input device 2 may provide a selection or positional information that correlates with a desired curvature of the desired backing path of travel of the trailer 14. Also, the trailer steering commands provided by the steering input device 2 can include information relating to a commanded change in the path of travel, such as an incremental change in the desired curvature, and information relating to an indication that the trailer 14 is to travel along a path defined by a longitudinal centerline axis of the trailer 14, such as a desired curvature value of zero that defines a substantially straight path of travel for the trailer 14. In a specific example, the steering input device 2 may include a movable control input device 4 for allowing a driver of the vehicle 12 to command desired trailer 34 steering actions or otherwise select and alter a desired curvature. For instance, the moveable control input device 4 may be a rotatable knob, which can be rotatable about a rotational axis extending through a top surface or face of the device 4.

As further shown in FIG. 2, vehicles with an integrated trailer brake control module, such as trailer brake controller 14, discussed above, provide calibration inputs 6a, 6b for adjustment of a gain applied to the brake torque demand signal to achieve the output trailer brake control signal. Such gain control is intended to be used upon a change in trailer load (either by removing payload or changing the trailer) before engaging in extended driving. As such, a test actuation input 8 is also provided that can allow the user to test the result of the trailer brake control signal output at a current gain level to determine if the resulting brake application is too low (resulting in too low a brake torque being applied) or too high (which may result in locking of the trailer wheels due to excessive brake torque). Accordingly, a user can add or remove gain using input 6 according to the test results. As can be appreciated, in a vehicle 12, such as the vehicle described in the present examples including system 10, would typically include the steering input device 2, the calibration inputs 6a, 6b, and the test actuation input 8 in separate devices.

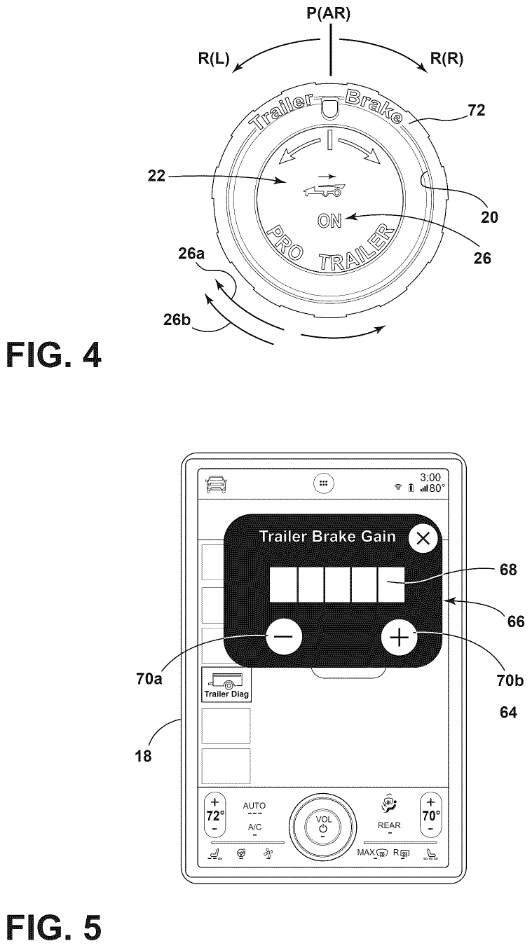

The present system 10 integrates the controls for the above-described trailer backup and trailer brake calibration functions in a single interface, specifically eliminating the need for a separate control device for trailer brake 36a, 36b testing and gain adjustment. Specifically, the present system 10 allows for control of the trailer backup assist and trailer brake testing functions using rotary input device 20, as shown in FIG. 4, by way of programming or other configuration of controller 24 and the integration of trailer brake control module 14 therein. In this respect, the system 10 can operate in the above-mentioned driving mode such that the trailer brakes 36a, 36b can be activated (i.e., for testing) by rotating the rotary input device 20, thus providing the above-mentioned “first” rotary inputs 26a. In one aspect, the controller 24, during the driving mode, can output the trailer brake actuation signal 28 to the trailer brakes 36a, 36b only upon the first rotary input 26 corresponding with rotation of the rotatable rotary element in the clockwise direction, with counter-clockwise rotation of the rotary input device 20 resulting in no change to the system state by being disregarded by controller 24.

While operating in the driving mode, the trailer brake gain can be adjusted by way of the vehicle HMI 18. As shown in FIG. 5, the HMI 18 includes a display screen 64 configured as a touch-screen interface. In this respect, responsive to receiving the first rotary input 26a from the rotatable rotary element 20, during operation in the driving mode, the controller 24 can present a trailer brake gain interface 66 on the display screen 64. As shown, the trailer brake gain interface 66 can include a graphical representation 68 of a current brake gain setting, which, as illustrated, may be in the form of a bar graph 68, with segments indicating the increments of gain adjustment. The trailer brake gain interface 66 can further include at least one virtual input 70 useable to adjust the brake gain setting. As shown, the virtual input 70 can be in the form of a pair of soft buttons 70a and 70b positioned adjacent the bar graph 68, with one soft button 70a being useable to incrementally adjust the brake gain down and the other soft button 70b being useable to incrementally increase the brake gain. In an example, the brake gain interface 66 can be displayed on display screen 64 upon controller 24 receiving the first rotary input 26a (e.g., by rotation of the rotary input device 20 in the clockwise direction) and simultaneously with the output of the test trailer brake signal 28 and can be continuously displayed for a predetermined interval (e.g., between 10 and 30 seconds and in one example about 15 seconds) or until cleared by a further user input. In a further aspect, the rotary input device 20 can include an indicator 72 that can, for example, be illuminated during system 10 operation in the driving mode to generally signal to the user that the rotary input device 20 is being used to actuate a trailer brake test. In a further aspect, the indicator 72 can include an arrow indicating that clockwise rotation is used for brake testing.

In the present example, the driving mode can be a default mode of operation, with the controller 24 operating in the driving mode upon vehicle start until receiving a specific input to operate outside of the driving mode. In particular, the controller 24 can enter a trailer backup assist mode, to execute the trailer backup assist functionality discussed above, upon receiving the above-mentioned activation signal 28 from the button 22 posited, for example, within the rotary input device 20. In a further example, the system 10 can also require that certain prerequisite conditions be met prior to activation of the trailer backup assist mode. For example, controller 24 can require that the vehicle 12 be shifted into reverse to operate in the trailer backup assist mode. In one implementation, the controller 24 can change from operation in the driving mode to the trailer backup assist mode upon the button 22 being depressed prior to the vehicle 12 being shifted into reverse or when already in reverse, with the controller 24 monitoring a powertrain control system 78 of the vehicle 12. In a further aspect, the controller 24 may require that the vehicle 14 be below a threshold speed (e.g., 5 miles per hour) prior to changing to the trailer backup assist mode. Such requirements can be communicated to the driver, via the HMI 18. When in the trailer backup assist mode, the controller 24 can use subsequent rotary inputs 26b, in either direction to control the vehicle steering according to operation of the curvature routine 74 to maintain the trailer 14 along a curvature corresponding with a magnitude of the inputs 26b (which may correspond with the amount by which the rotary input device 20 is turned. A second indicator 76 can be incorporated into the rotary input device 20 and can be illuminated to indicate operation in the trailer backup assist mode, which can also be communicated via HMI 18.

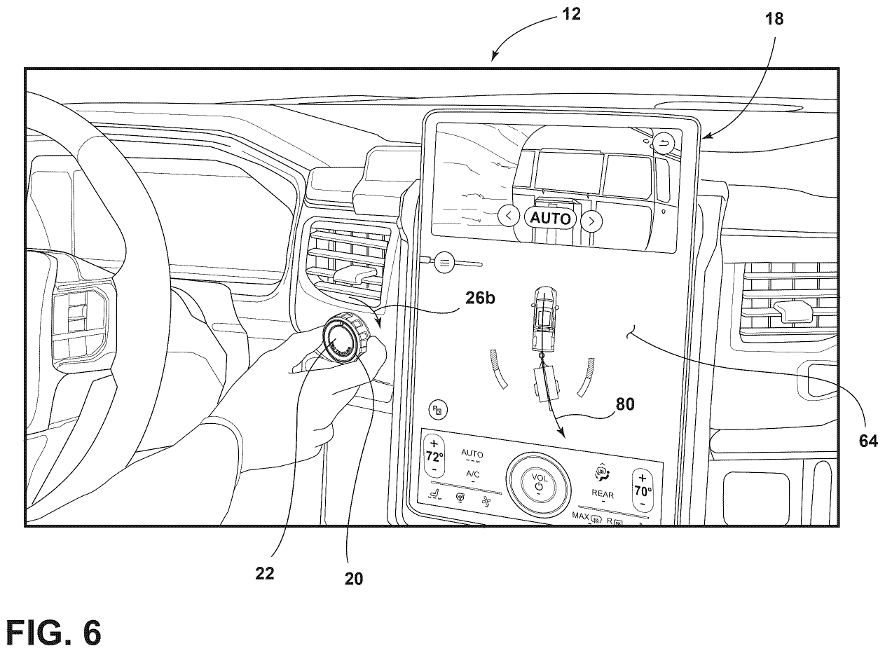

The rotary input device 20, as illustrated in FIG. 4, includes a rotating knob 30 that may be biased (e.g., by a spring return) to a center, or at-rest position P(AR) between opposing rotational ranges of motion R(R), R(L). In the illustrated embodiment, a first one of the opposing rotational ranges of motion R(R) is substantially equal to a second one of the opposing rotational ranges of motion R(L), R(R). To provide a tactile indication of an amount of rotation of the rotatable knob 30, a torque that biases the knob 30 toward the at-rest position P(AR) can increase (e.g., non-linearly) as a function of the amount of rotation of the rotary input device 20 with respect to the at-rest position P(AR). As discussed above, a driver can turn the rotary input device 20 to provide a desired trailer 14 path curvature 80, as shown on the example implementation of HMI 18 in FIG. 6, while the driver of the vehicle 12 backs the trailer 14. In the illustrated embodiment, the rotary input device 20 rotates about a central axis between a center or middle position corresponding to a substantially straight backing path of travel and various rotated positions on opposing sides of the middle position, commanding a desired curvature corresponding to a radius of the desired backing path of travel for the trailer 14 at the commanded rotated position. It is contemplated that the rotary input device 20 may be configured in accordance with embodiments of the disclosed subject matter and omit a means for being biased to an at-rest position P(AR) between opposing rotational ranges of motion. In one example, the controller 24 can revert to the driving mode upon the vehicle 12 being shifted into drive, the vehicle 12 exceeding a predetermined speed threshold, or upon a subsequent command from the user, which may be received via button 22 or HMI 18. When in the driving mode, movement away from the at rest position P(AR) into the clockwise range of motion R(R) causes controller 24 to output a trailer brake signal 28, as discussed above. In one implementation, the trailer brake signal 28 can be proportional to the magnitude of the rotational movement within the clockwise range of motion R(R).

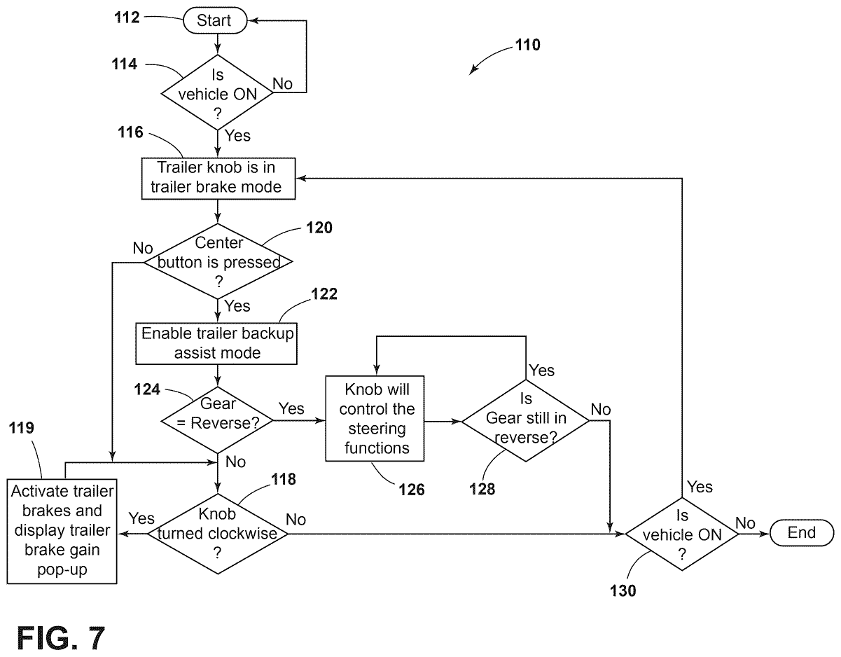

Turning to FIG. 7, a method 110 of operation implemented by the present system is shown. The method starts (step 112) upon the vehicle being switched on (step 114). As discussed above, the method 110 include initially operating in the driving mode (step 116), wherein the rotary input device 20 functions to operate the trailer brakes 36a, 36b, such as for testing of a current brake gain setting, by way of clockwise rotation of the rotary input device 20 (step 118), at which point the trailer brakes 36a, 36b are activated and the brake gain interface 66 is displayed (119). Upon receipt of the activation signal 28 by way of the button 22 being depressed by the user (step 120), a standby mode is entered (step 122) wherein the operation continues in the driving mode while waiting for the above-described prerequisite conditions to be met. As shown, when the vehicle 12 is shifted into reverse (step 124), the trailer backup assist mode is entered, in which rotation of the rotary input device 20 is used as a curvature input by the controller 24 in controlling the steering system 16 to maintain a desired trailer 14 curvature 80 (step 126). During such operation, the vehicle state is monitored to determine if, for example, the vehicle 12 is switched out of reverse (step 128), at which point, the driving mode is resumed while the vehicle remains on (step 130).

It is to be understood that variations and modifications can be made on the aforementioned structure without departing from the concepts of the present disclosure, and further it is to be understood that such concepts are intended to be covered by the following claims, unless these claims by their language expressly state otherwise.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A control system for a vehicle including a trailer brake control module, and a steering system, the control system comprising:
a vehicle human machine interface including a rotatable rotary element and a button positioned adjacent the rotatable rotary element; and
a controller:
operating in a driving mode including receiving a first rotary input from the rotatable rotary element and outputting a trailer brake actuation signal to the trailer brake control module proportional to a magnitude of the rotary input; and
responsive to receipt of an activation signal received from the button, operating in a trailer backup mode, including receiving a second rotary input from the rotatable rotary element and outputting a vehicle steering command to the steering system based on a magnitude and direction of the second rotary input.

2. The control system of claim 1, wherein:
the vehicle human machine interface further includes a display screen; and
further responsive to receiving the first rotary input from the rotatable rotary element when operating in the driving mode, the controller presents a trailer brake gain interface on the display screen, the trailer brake gain interface including a graphical representation of a brake gain setting used to derive the trailer brake actuation signal.

3. The control system of claim 2, wherein the trailer brake gain interface further includes at least one virtual input corresponding with an input to adjust the brake gain setting.

4. The control system of claim 1, wherein the controller operates in the trailer backup mode, responsive to receipt of the trailer backup activation signal, only upon detection of at least one prerequisite vehicle condition.

5. The control system of claim 4, wherein the prerequisite vehicle condition is a vehicle transmission being configured in a reverse gear.

6. The control system of claim 4, wherein the prerequisite vehicle condition further includes a vehicle speed being below a threshold speed.

7. The control system of claim 4, wherein the controller operates in the trailer backup mode, only upon detection of the at least one prerequisite vehicle condition within a predetermined time interval of receiving the trailer backup activation signal.

8. The control system of claim 1, wherein the controller outputs the trailer brake actuation signal to the trailer brake control module only upon the first rotary input corresponding with rotation of the rotatable rotary element in a clockwise direction.

9. The control system of claim 1, wherein the human machine interface further includes at least one illuminable element indicating controller operation in a respective one of the driving mode or the trailer backup mode.

10. The control system of claim 1, wherein the button is positioned within an interior of the rotatable rotary element.

11. A control system for a vehicle including a trailer brake control module, and a steering system, the control system comprising:
a vehicle human machine interface including a rotatable input device, a button positioned adjacent the rotatable input device, and display screen; and
a controller receiving a first rotary input from the rotatable input device; and
outputting a trailer brake actuation signal to the trailer brake control module proportional to a magnitude of the rotary input; and
presenting a trailer brake gain interface on the display screen, the trailer brake gain interface including a graphical representation of a brake gain setting used to derive the trailer brake actuation signal.

12. The control system of claim 11, wherein the trailer brake gain interface further includes at least one virtual input corresponding with an input to adjust the brake gain setting.

13. The control system of claim 11, wherein the controller:
outputs the trailer brake actuation signal to the trailer brake control module proportional to the magnitude of the rotary input when operating in a driving mode; and
responsive to receipt of an activation signal received from the button, operates in a trailer backup mode, including receiving a second rotary input from the rotatable rotary element and outputting a vehicle steering command to the steering system based on a magnitude and direction of the second rotary input.

14. The control system of claim 13, wherein the controller operates in the trailer backup mode responsive to receipt of the trailer backup activation signal only upon detection of at least one prerequisite vehicle condition including:
a vehicle transmission being configured in a reverse gear; and
a vehicle speed being below a threshold speed.

15. The control system of claim 14, wherein the controller operates in the trailer backup mode, only upon detection of the at least one prerequisite vehicle condition within a predetermined time interval of receiving the trailer backup activation signal.

16. The control system of claim 13, wherein the human machine interface further includes at least one illuminable element indicating controller operation in a respective one of the driving mode or the trailer backup mode.

17. The control system of claim 1, wherein the controller outputs the trailer brake actuation signal to the trailer brake control module only upon the first rotary input corresponding with rotation of the rotatable rotary element in the clockwise direction.

18. A vehicle, comprising:
a steering system;
a trailer brake control module;
a vehicle human machine interface including a rotatable rotary element, a button positioned adjacent the rotatable rotary element, and a display screen; and
a controller:
operating in a driving mode including receiving a first rotary input from the rotatable rotary element and outputting a trailer brake actuation signal to the trailer brake control module proportional to a magnitude of the rotary input and presenting a trailer brake gain interface on the display screen, the trailer brake gain interface including a graphical representation of a brake gain setting used to derive the trailer brake actuation signal; and
responsive to receipt of an activation signal received from the button, operating in a trailer backup mode, including receiving a second rotary input from the rotatable rotary element and outputting a vehicle steering command to the steering system based on a magnitude and direction of the second rotary input.

19. The vehicle of claim 18, wherein the trailer brake gain interface further includes at least one virtual input corresponding with an input to adjust the brake gain setting.

20. The vehicle of claim 18, further including a transmission and a speed sensor, wherein:
the controller operates in the trailer backup mode responsive to receipt of the trailer backup activation signal only upon detection of at least one prerequisite vehicle condition including:
the vehicle transmission being configured in a reverse gear; and
the vehicle speed sensor indicating a vehicle speed below a threshold speed.
